(19) United States
(12) Patent Application Publication
(10) Pub. No.: US 2014/0235418 A1
(43) Pub. Date: Aug. 21, 2014

(54) Partitioned Game Card Holder Using Monocoque Construction

(71) Applicant: Richard M. Haddock, Emerald Hills, CA (US)

(72) Inventor: Richard M. Haddock, Emerald Hills, CA (US)

(21) Appl. No.: 14/165,568

(22) Filed: Jan. 27, 2014

Related U.S. Application Data
(60) Provisional application No. 61/757,208, filed on Jan. 27, 2013.

(51) Int. Cl. B31D 5/04

(52) U.S. Cl. CPC B31D 5/04
USPC 493/351

(57) ABSTRACT

The invention provides an improved game playing card holder made from monocoque construction providing a plurality of card compartments using raised fins through linear slits in the frame. The fins protrude vertically from the card holding surface provides a separation boundary between card types as required by individual game requirements. The rear support of the card compartment is a common wall providing a uniform presentation of the decks to the dealer. The supporting top surface is raised at an approximate 20 degree angle from the base, with the front card edge of each deck protruding beyond the front support of the card base, allowing ease of access to the cards to create improved card handling and dealing characteristics of the holder. The metallic structure allows application of electrostatic powder coat finishes providing long durability with enhanced appearance.

### BACKGROUND OF THE INVENTION

Game card holders are well known in the art and come in a multitude of designs and materials. Typical game card holders are formed from plastic, wood, or cardboard. Drawbacks from these types of card holding products include ease of breakage or damage in use, high cost of injection molding dies for plastic versions, need for multiple pieces and assembly for wood and cardboard, potential damage from spilled liquids or drops from heights, bulk of materials, and excessive product size and weight required to provide mechanical strength. The subject of this invention teaches a method and design to eliminate the traditional game card holder drawbacks and provides improvement to the state of the art.

### SUMMARY

An ultra-weight and high strength multi-partitioned game card holder is formed from a single sheet of material using stressed skin monocoque construction methods with internal locking mechanisms in the preferred embodiment. The formed game card holder has a series of card partitions separated by thin curved fins which also function as the locking fins to secure the construction. An integrated card back support and sloped elevated base design optimize the design for ease of use for games requiring frequent handling of cards. High stiction polymer low profile feet mounted to the base of the unit provide a solid platform for operational use on a variety of playing surfaces.

### DESCRIPTION OF THE FIGURES

FIG. 100: Flat pattern prior to bending showing typical layout for a card holder

FIG. 200: Finished Card Holder After Bending and Separator Fins in Locked Position

FIG. 300: Locking Fin Detail

FIG. 400: In Process Bending Detail

FIG. 500: End view showing construction detail after locking fins are inserted

FIG. 600: Bottom view of Baseplate showing Fin Cavities

### DESCRIPTION

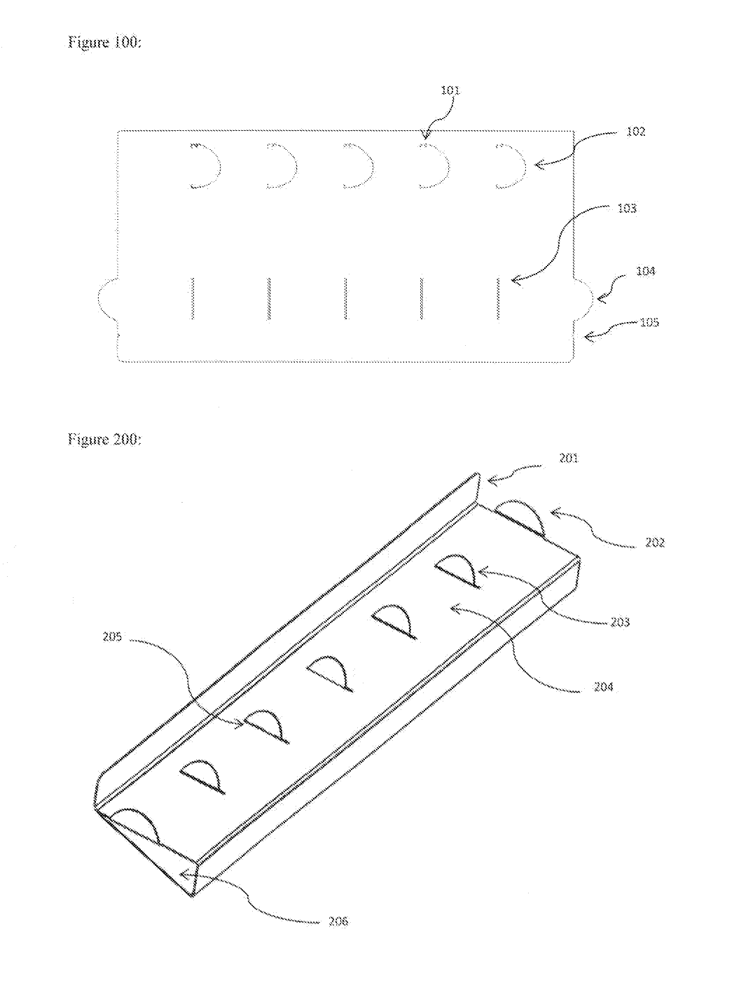

The invention is implemented by constructing a single cut panel (FIG. 100) of the appropriate material (grade 5052 alloy aluminum in 22 gauge thickness is the preferred material), providing high tensile strength, excellent bending and forming properties, good machinability, and low material cost. FIG. 100 illustrates the following features: 101: Locking notch on separation Fin; 102: Partition Separating Fin; 103: Fin Slot; 104: End Fin; 105: Rear Card Support Bending Index Notch.

The preferred method is to use water jet cut cutting to create the initial flat panel part used to form the product which reduces material waste cost, labor costs, and eliminates the need for costly tooling for low volume production. Bending the flat panel in 3 stages (FIG. 400) starts the formation of the stressed monocoque frame. Feature 401 of FIG. 400 shows initial bends for rear card support and end fins, front riser bent into position prior to base plate bend.

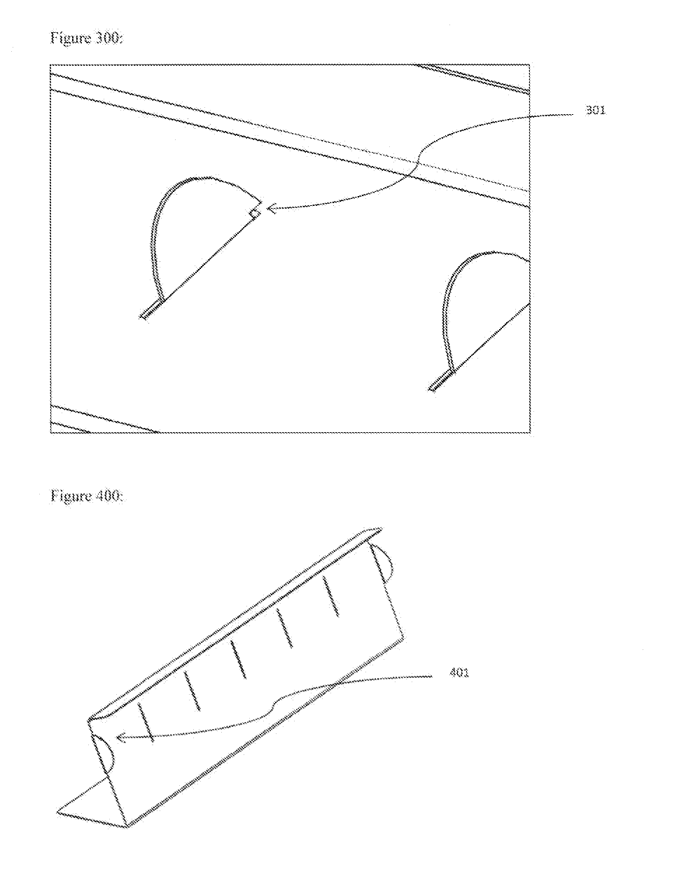

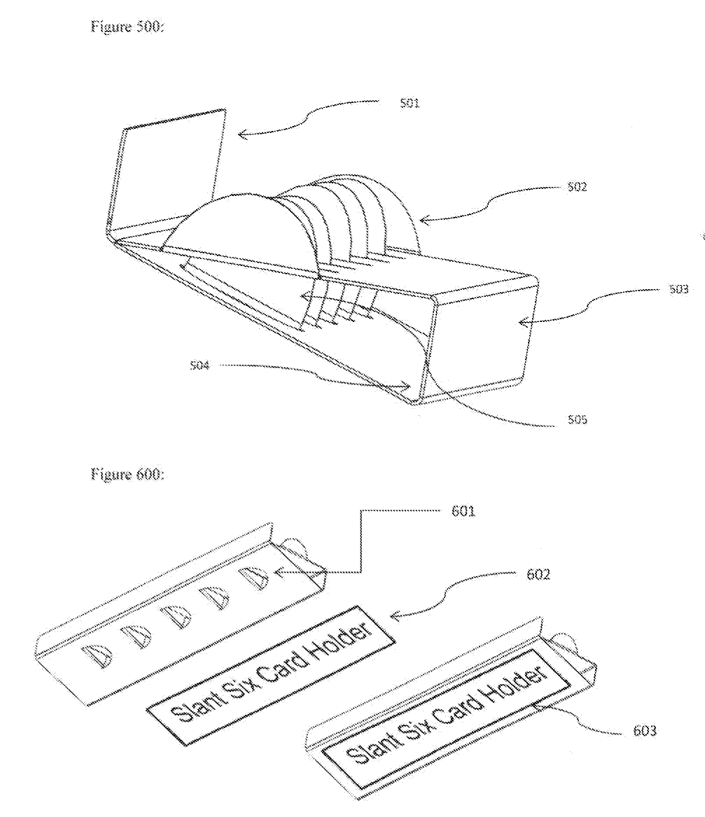

The thin skin frame structure can be hand formed using traditional sheet metal bending tools in a few seconds and results in an elongated tube type structure open along the long axis. The final construction secures the base surface to the top surface by a series of interlocking notches on the partitioning fins inserted through slots in the upper surface of the card holder (FIG. 300) forming a closed structure (FIG. 500). Feature 301 of FIG. 300 shows a Fin notch locked into the Rear fin slot. FIG. 500 shows the following features: 501: Rear card support formed; 502: End fins bent into position; 503: Front riser formed; 504: 20 degree card holder slope formed by base plate bend and front riser; 505: Five internal fins bent into position through upper slots and locked into place by notches.

Bending two end half circular fins upward completes the formation of the card holding partitions (FIG. 200). FIG. 200 illustrates the following features: 201: Rear Card Support After Bending; 202: End Fin Separator; 203: Partition Separating Fin; 204: Card partition space; 205: Locking Notch; 206: 20 degree slope formed in base to top angle planes.

In the preferred implementation, the raw aluminum surfaces are finished using high temperature baked polymer powder coating for a durable and lasting appearance, enhancing product appeal over traditional card holders. The addition of low durometer silicon self-adhesive feet on the bottom surface is required to generate sufficient stiction to eliminate sliding or motion of the card holder during vigorous gaming conditions. The cavities on the underside formed by the creation of the locking fins structures (FIG. 600) are covered with a self-adhesive printed label to provide a product labeling surface and to provide protection against accidental insertion of fingers into the cut recesses of the product. FIG. 600 shows the following features 601: Cavities in bottom Baseplate formed after Separating Tabs are bent and positioned through upper plate slots and notches locked; 602: Bottom label, polyester self-adhesive preferred; 603: Cavities are covered by product label when finishes.

The typical implementation of the product will provide six partitions for different gaming cards, each separated by a thin (25 thousands of an inch) curved fin, minimizing the overall product length to less than ¼″ over the length of the six cards themselves. No other game card holder provides such low physical overhead. The resulting weight of the product is less than four ounces, less than the supported game cards themselves, again minimizing the product impact on the game storage and transport overhead. The game cards are partially supported by the sloped base surface at an approximate 20 degree angle, with the last ½″ of card surface protruding outside the holder. This provides and optimum presentation of the card stock to allow fast and secure handling of the cards while dealing or replacing cards in play.

What is claimed is:

1. A method of forming a game playing card holder from a single flat sheet of material comprising the following steps:
a. Cutting a pattern having features capable of being bent into a closed hollow body and
b. Fabricating an elongated monocoque shell capable of supporting and appropriately distributing decks of cards across the upper surface and
c. Having interior bent fins protruding up and through the upper surface to provide separation of card compartments and
d. Locking the monocoque body into position clicking of notches in the separating fins into matching slots as the body is formed.

2. The structure as per claim 1 holding any number of playing cards in more than one compartment formed from a single piece of metal less than 0.050″ thick that is folded into a contiguous surface with locking notches.

3. The structure as per claim 1 holding between 1 and 60 playing cards in each compartment with multiple compartments formed from a single piece of metal less than 0.050″ thick that is folded into a contiguous surface with locking notches.

4. The structure as per claim 1 holding between 1 and 60 playing cards in each compartment with multiple compartments between 1.0″ to 4.0″ wide formed from a single piece of metal less than 0.050″ thick that is folded into a contiguous surface with locking notches.

5. The structure as per claim 1 holding between 1 and 60 playing cards in each compartment with less than eight compartments between 1.0″ to 4.0″ wide formed from a single piece of metal less than 0.050″ thick that is folded into a contiguous surface with locking notches.

6. The structure as per claim 1 holding between 1 and 60 playing cards in each compartment with multiple compartments each of an equal or unequal width formed from a single piece of metal less than 0.050″ thick that is folded into a contiguous surface with locking notches.

7. The structure as per claim 1 holding between 1 and 60 playing cards in each compartment with multiple compartments each of an equal width formed from a single piece of metal less than 0.050″ thick that is folded into a contiguous surface with locking notches.

8. The structure as per claim 1 holding a variable amount of playing cards in compartments of variable heights with multiple compartments each of an equal width formed from a single piece of metal less than 0.050″ thick that is folded into a contiguous surface with locking notches.

9. The structure as per claim 1 holding a variable amount of playing cards in compartments of variable heights with multiple compartments each of an equal width formed from a single piece of aluminum less than 0.050″ thick that is folded into a contiguous surface with locking notches.

10. The structure as per claim 1 holding a variable amount of playing cards in compartments of variable heights with multiple compartments each of an equal width formed from a single piece of steel or related alloy less than 0.050″ thick that is folded into a contiguous surface with locking notches.

11. An Alternate method of forming a game playing card holder from a single flat sheet of material comprising the following steps:
a. Cutting a pattern having features capable of being bent into a closed hollow body and
b. Fabricating an elongated monocoque shell capable of supporting and appropriately distributing decks of cards across the upper surface and
c. Having interior bent fins protruding up and through the upper surface to provide separating of card compartments and
d. Welding or affixing with adhesives the rear seam of the bottom surface to the top surfaces to form a closed hollow body.

12. A method of covering the open cut areas in the bottom surface with a product label to eliminate risk of injury from handling and improve appearance.
